(19) United States
(12) Patent Application Publication
(10) Pub. No.: US 2010/0034176 A1
(43) Pub. Date: Feb. 11, 2010

(54) METHOD AND APPARATUS FOR DYNAMICALLY ACTIVATING AND DEACTIVATING A SUPPLEMENTARY CELL FOR A WCDMA SYSTEM

(75) Inventors: Youn H. HEO, Suwon-si (KR); Young Bum Xim, Seoul (KR); Ju Ho Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/538,585

(22) Filed: Aug. 10, 2009

(30) Foreign Application Priority Data
Aug. 8, 2008 (KR) 10-2008-0077955
Aug. 21, 2008 (KR) 10-2008-0081725
Sep. 22, 2008 (KR) 10-2008-0092714

(51) Int. Cl. H04W 72/04

(52) U.S. Cl. 370/335

(57) ABSTRACT

A method and apparatus for dynamically activating and deactivating a supplementary cell in Dual-Cell HSDPA service of a Universal Mobile Communication Service (UMTS) system. In a supplementary cell activation and deactivation method, a user equipment receives a supplementary cell activation command from a base station; compares an uplink transmission power with a predetermined threshold value; transmits a supplementary cell activation reply, when the uplink transmission power is equal to or greater than the threshold value; and transmits a supplementary cell deactivation reply, when the uplink transmission power is less than the threshold value.

### PRIORITY

This application claims priority to applications filed in the Korean Intellectual Property Office on Aug. 8, 2008, Aug. 21, 2008, and Sep. 22, 2008, and assigned Serial Nos. 10-2008-0077955, 10-2008-0081725 and 10-2008-0092714, respectively, the contents of which are incorporated herein by reference.

### BACKGROUND OF THE INVENTION

1. Field of the Invention

The present invention relates generally to a method and apparatus for providing a User Equipment (UE) with a high speed data service using multiple carriers. In particular, the present invention relates to a method and apparatus for dynamically activating and deactivating a supplementary cell in Dual-Cell High Speed Downlink Packet Access (HSDPA) service of a Universal Mobile Telecommunication Service (UMTS) system, which is a 3^{rd} Generation (3G) mobile communication system based on the Wideband Code Division Multiple Access (WCDMA).

2. Description of the Related Art

HSDPA is an enhanced 3G mobile communication protocol which allows networks based on UMTS to support higher data transfer speed and capacity with the features of High Speed-Downlink Shared Channel (HS-HSCH) and other control channels introduced along with the HS-HSCH.

In order to achieve higher data transfer speed, HSDPA has introduced some novel techniques. Among them, Adaptive Modulation and Coding (AMC) determines the modulation and coding schemes of data channels according to the channel conditions between a node B and a UE so as to improve the entire resource utilization efficiency. The combination of the modulation scheme and coding scheme is called a Modulation and Coding Scheme (MCS), and a plurality of MCS levels, i.e., 1^{st} to n^{th} MCS levels, can be defined. AMC determines an MCS level depending on the channel conditions between the cell and the UE.

FIG. 1 is a sequence diagram illustrating operations of a conventional HSDPA system including a cell and a UE.

Referring to FIG. 1, a UE 102 first transmits a Channel Quality Indicator (CQI) to a cell 101. Because the UE 102 does not know when the data are transmitted in downlink, it transmits the CQI information periodically (103). When there is data to be sent, Node B 101 performs scheduling based on the CQI. In the scheduling process, Node B determines a number of code channels available for allocation and an MCS level. Such information is transmitted to the UE 102 through a High Speed-Shared Control Channel (HS-SCCH) (105).

The HS-SCCH is received by the UE 102 in a Transmission Time Interval (TTI), and the UE 102 receives data by demodulating the HS-PDSCH 106 with reference to the HS-SCCH. In order to make a status report for Hybrid Automatic Repeat Request (HARQ), the UE 102 performs Cyclic Redundancy Check (CRC) to determine Acknowledgement/Non-Acknowledgement (ACK/NACK) (103). If the data received includes an error, the UE 102 transmits a NACK to Node B 101 to request retransmission of the data; and otherwise, transmits an ACK to Node B 101 (107). The status reports of ACK/NACK and CQI are transmitted through the HS-DPCCH (108).

FIG. 2 is a timing diagram illustrating transmissions of physical channels of an HSDPA system.

Referring to FIG. 2, CQIs 205, 206, and 207 are periodically transmitted via the HS-DPCCH. Node B transmits two slots of the HS-SCCH before it begins transmitting the HS-PDSCH, in order for the UE to check the information on the demodulation of the HS-PDSCH. The ACK/NACK information 204 is transmitted 7.5 slots 203 after the transmission of the HS-PDSCH 202 in consideration of the demodulation and decoding of the data carried by the HS-PDSCH.

FIG. 3 is a conceptual diagram illustrating a Dual-Cell HSDPA service of a UMTS system.

Unlike the conventional HSDPA in which the UE measures received signals strengths of the cells and connects to the most appropriate cell based on the measurements, the Dual-Cell HSDPA is characterized in that the UE 308 connects to two different cells 301 and 302 defined by two different carriers 303 and 304 of a Node B. The UE 308 simultaneously receives the HSDPA signals from the second cell 302 in the first carrier f1 304 and from the first cell 301 in the second carrier f2 303.

In the WCDMA system, the transmission bandwidth of a cell is 5 MHz, such that the UE must have a reception capability of 10 MHz for supporting Dual-Cell HSDPA. Because the HSDPA signals are received from two cells, the maximum transmission rate increases twice. In an uplink, however, the Dual-Cell transmission function is not supported, whereby the uplink channel is transmitted to only one cell. Even in downlink transmission, common and dedicated channels that are not related to the HSDPA are received from a single cell. Typically, the cell that controls the uplink channel, common downlink channel, and dedicated downlink channel is called an “anchor cell” and the other cell is called “supplementary cell”. Although the description is done with two cells (two carriers), the Dual-Cell HSDPA system can actually be implemented with multiple supplementary cells with an anchor cell.

In order for the Dual-Cell HSDPA service to support HARQ and AMC, the ACK/NACK and CQI are should be transmitted to the respective cells, whereby the uplink channel assigned to the anchor cell must be configured to carry the ACK/NACKs and CQIs destined for the anchor and supplementary cells. As a simple approach to achieve this purpose, a code multiplexing in which two codes are assigned to the uplink for the anchor cell can be considered. This approach is very simple but has a problem in that the increment of a number of channels to be transmitted increases a Peak to Average Power Ratio (PAPR) ratio, resulting in reduction of uplink coverage.

Because the channels of the anchor and supplementary cells are set by higher layer signaling, the UE can start receiving HSDPA service from the anchor and supplementary cells when the higher layer signaling is received.

In Dual-Cell HSDPA service, the UE must receive and decode the signaling information at every HS-SCCH frame time to check whether it is scheduled for receiving data, and transmits the CQI information for the anchor and supplementary cells through the HS-DPCCH periodically, whereby the UE operating in the Dual-Cell HSDPA mode, despite inefficient Dual-Cell HSDPA service situation, causes significant power consumption and uplink channel interference unnecessarily.

It is preferred that the Dual-Cell HSDPA is deactivated in the following situations:
When no downlink data exists
When the downlink channel condition of the supplementary cell is bad
When it is difficult for the UE to transmit two HS-DPCCHs due to the bad uplink channel condition and lack of transmission power

However, currently, no discussion on how to activate and deactivate the Dual-Cell HSDPA function of the UE depending on the service efficiency has been made in detail.

### SUMMARY OF THE INVENTION

Accordingly, the present invention has been designed in order to overcome the at least the above-mentioned problems of the prior art, and the present invention provides a method and apparatus for efficiently managing the Dual-Cell HSDPA function of a UE, depending on the communication environment in a WCDMA system.

Also, the present invention provides a method and apparatus for dynamically activating and deactivating a supplementary cell in the Dual-Cell HSDPA session of a WCDMA system, wherein the UE informs the anchor cell of its power condition.

In accordance with an embodiment of the present invention, a supplementary cell activation and deactivation method of a user equipment for a Wideband Code Division Multiple Access (WCDMA) system supporting multi-carrier transmission includes receiving a supplementary cell activation command from a base station; comparing an uplink transmission power with a predetermined threshold value; transmitting a supplementary cell activation reply in response to the supplementary cell activation command, when the uplink transmission power is equal to or greater than the threshold value; and transmitting a supplementary cell deactivation reply in response to the supplementary cell activation command, when the uplink transmission power is less than the threshold value.

In accordance with another embodiment of the present invention, a supplementary cell activation and deactivation method of a base station for a Wideband Code Division Multiple Access (WCDMA) system supporting multi-carrier transmission includes receiving a reply transmitted by a user equipment in response to a supplementary cell activation command; and controlling activation and deactivation of a supplementary cell by activating the supplementary cell, when the reply is a supplementary cell activation reply, and deactivating the supplementary cell, when the reply is a supplementary cell deactivation reply.

In accordance with another embodiment of the present invention, a user equipment for activating and deactivating supplementary cell in a Wideband Code Division Multiple Access (WCDMA) system supporting multi-carrier transmission includes a supplementary cell activation command extractor for extracting a supplementary cell activation command from a channel transmitted by a base station; a status report generator for generating a response to the supplementary cell activation command; and a controller for comparing an uplink power with a predetermined threshold value and controlling the status report generator to generate and transmit a supplementary cell activation response, when the uplink power is equal to or greater than the threshold value, and to generate and transmit a supplementary cell deactivation response, when the uplink power is less than the threshold value.

In accordance with another embodiment of the present invention, a base station for activating and deactivating supplementary cell in a Wideband Code Division Multiple Access (WCDMA) system supporting multi-carrier transmission includes a supplementary cell activation command generator for generating and transmitting a supplementary cell activation command to a user equipment; a status report extractor for extracting a response from a channel transmitted by the user equipment in response to the supplementary cell activation command; and a controller for controlling to activate a supplementary cell, when the response is a supplementary cell activation response, and to deactivate the supplementary cell, when the response is a supplementary cell deactivation response.

### BRIEF DESCRIPTION OF THE DRAWINGS

The above and other aspects, features, and advantages of the present invention will be more apparent from the following detailed description in conjunction with the accompanying drawings, in which:

FIG. 1 is a sequence diagram illustrating operations of a conventional HSDPA system including a cell and a UEFIG. 2 is a timing diagram illustrating transmissions of physical channels of a conventional HSDPA system;

FIG. 3 is a conceptual diagram illustrating a Dual-Cell HSDPA service of a UMTS system;

FIG. 4 is a timing diagram illustrating transmissions of physical channels when a channel condition of a UE is good according to an embodiment of the present invention;

FIG. 5 is a timing diagram illustrating transmissions of physical channels when a channel condition of a UE is bad according to an embodiment of the present invention;

FIG. 6 is a flowchart illustrating a dynamic supplementary cell activation and deactivation method for a Dual-Cell HSDPA system in view of a UE according to an embodiment of the present invention;

FIG. 7 is a flowchart illustrating a dynamic supplementary cell activation and deactivation method for a Dual-Cell HSDPA system in view of Node B according to an embodiment of the present invention;

FIG. 8 is a block diagram illustrating a configuration of a UE for implementing a dynamic supplementary cell activation and deactivation method according to an embodiment of the present invention;

FIG. 9 is a block diagram illustrating a configuration of a Node B for implementing a dynamic supplementary cell activation and deactivation method according to an embodiment of the present invention;

FIG. 10 is a timing diagram illustrating transmissions of channels according to an embodiment of the present invention;

FIG. 11 is a flowchart illustrating a dynamic supplementary cell activation and deactivation method for a Dual-Cell HSDPA system in view of a UE according to an embodiment of the present invention;

FIG. 12 is a flowchart illustrating a dynamic supplementary cell activation and deactivation method for a Dual-Cell HSDPA system in view of a Node B according to an embodiment of the present invention;

FIG. 13 is a block diagram illustrating a configuration of a UE for implementing a dynamic supplementary cell activation and deactivation method according to an embodiment of the present invention;

FIG. 14 is a block diagram illustrating a configuration of a Node B for implementing a dynamic supplementary cell activation and deactivation method according to an embodiment of the present invention; and

FIG. 15 is a flowchart illustrating a dynamic supplementary cell activation method for a Dual-Cell HSDPA system in view of a UE according to an embodiment of the present invention.

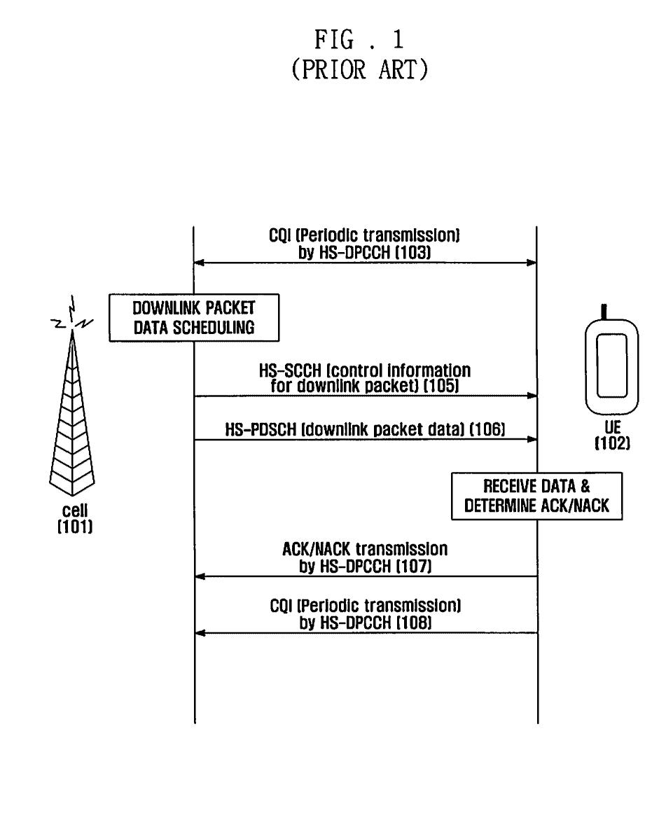

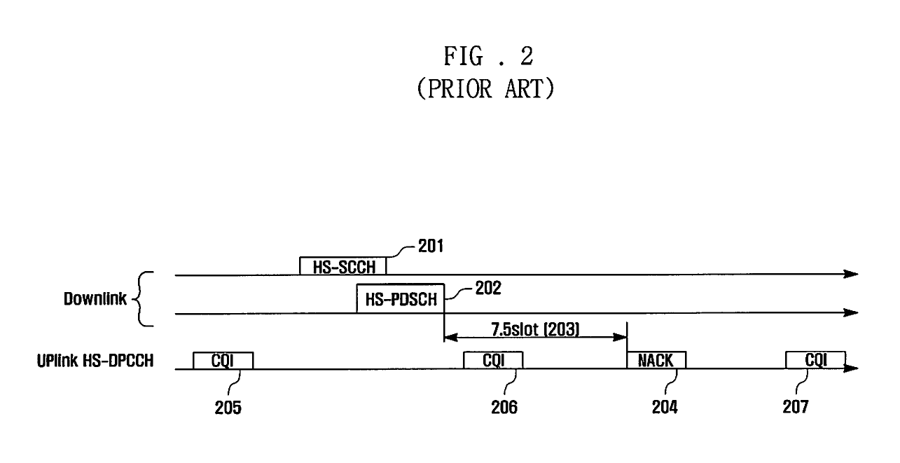

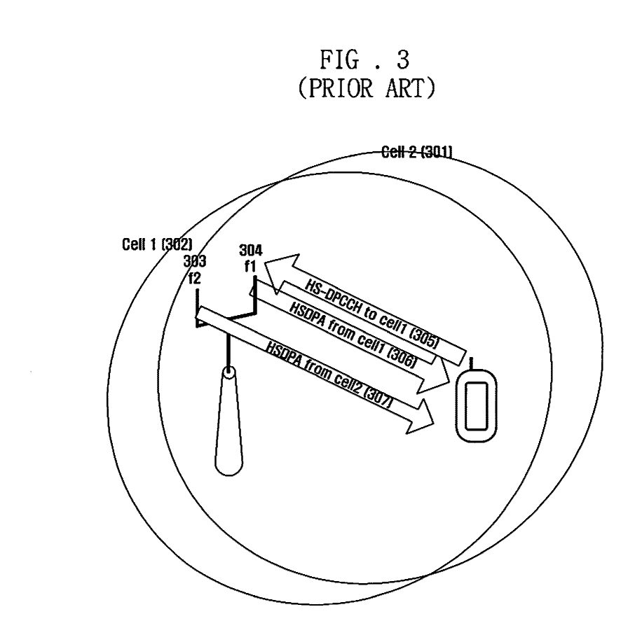

### DETAILED DESCRIPTION OF EMBODIMENTS OF THE PRESENT INVENTION

Embodiments of the present invention will be described in detail herein below with reference to the accompanying drawings. The same reference numbers are used throughout the drawings to refer to the same or like parts. Additionally, detailed descriptions of well-known functions and structures incorporated herein may be omitted to avoid obscuring the subject matter of the present invention.

The terms used in the following descriptions are often defined in consideration of the corresponding functions in the embodiments of the present invention and thus can be replaced with other words according to the intention and practice of user and operator. Accordingly, the definitions of the terms should be made based on the contents through the entire description of the present invention.

Additionally, although the dynamic supplementary cell activation and deactivation method is described below in association with a Dual-Cell HSDPA system as an example, it is obvious that the present invention can be applied to various mobile communication systems supporting high speed data service simultaneously using multiple carriers.

In the following description, an efficient method and apparatus for dynamically activating a supplementary cell in a Dual-Cell HSDPA-enabled mobile communication system in which multiple cells provide a UE with the HSDPA service is described. However, the embodiments of the present invention are not limited thereto. For example, the dynamic supplementary cell activation and deactivation method can be applied to a High Speed Uplink Packet Access (HSUPA) system.

In accordance with an embodiment of the present invention, an HSDPA service of a supplementary cell involved in a Dual-Cell HSDPA session will be activated when the dual cell HSDPA service is efficient and deactivated when the dual cell HSDPA service is inefficient. In order to achieve this purpose, a cell transmits a command for activating the HSDPA service of the supplementary cell through an HS-SCCH. In a downlink, the cell can check the Dual-Cell HSDPA capability of the UE based on the cell buffer status received from the network and the CQI received from the UE. However, in an uplink, it is difficult for the cell to check the uplink transmission power condition of the UE. Accordingly, in accordance with an embodiment of the present invention, the UE reports its transmission power condition to the cell when the cell attempts to activate the Dual-Cell HSDPA service.

More specifically, when a cell has activated a Dual-Cell HSDPA service, the UE reports to the cell if an uplink power headroom is less than a predetermined threshold value. Upon receipt of the uplink power condition report, the cell determines, based on the uplink power condition report, whether to activate or deactivate the HSDPA service of the supplementary cell or schedule only one cell to prevent the UE from transmitting an ACK/NACK and CQI to the both cells simultaneously.

In accordance with an embodiment of the present invention, the anchor cell first activates the HSDPA service of the supplementary cell using an HS-SCCH, and the UE sends a status report indicating its transmission power by means of the HS-DPCCH, if the uplink transmission power is weak, when receiving the HS-SCCH.

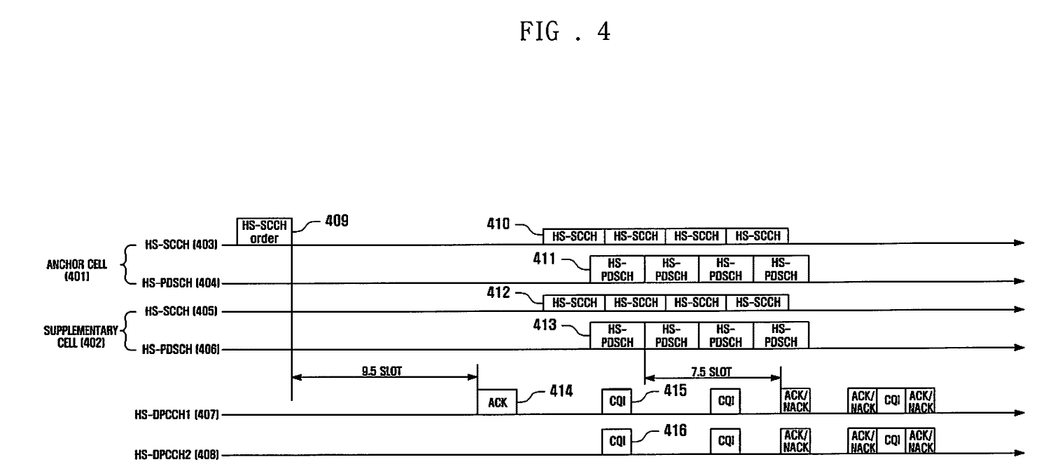

FIG. 4 is a timing diagram illustrating transmissions of physical channels when a channel condition of a UE is good according to an embodiment of the present invention.

Referring to FIG. 4, an anchor cell first transmits an HS-SCCH to activate the HSDPA service of the supplementary cell (409). The HS-SCCH carries control information rather than scheduling information for data transmission, such that it is commonly referred to as an “HS-SCCH order” (hereinafter the term “supplementary cell activation command” is interchangeably used).

If the HS-SCCH order has been received successfully, the UE transmits an ACK to inform the anchor cell of safe receipt at a predetermined time. After a predetermined duration has elapsed from the transmission of the HS-SCCH order, both the anchor and supplementary cells start transmitting data using the HS-PDSCH. Because the UE Dual-Cell HSDPA mode has been activated in response to the HS-SCCH order, the UE simultaneously receives the HS-PDSCHs from both the anchor and supplementary cells and performs demodulation and decoding on the data carried by the HS-PDSCHs.

After the data decoding has completed, the UE transmits an ACK/NACK of the anchor cell's HS-PDSCH to the anchor cell via an HS-DPCCH1, and transmits an ACK/NACK of the supplementary cell's HS-PDSCH to the supplementary base station via an HS-DPCCH2. FIG. 4 illustrates operations of the Dual-Cell HSDPA system in which both the anchor and supplementary cells can transmit the HS-DPCCHs because the uplink power headroom of the UE is large enough.

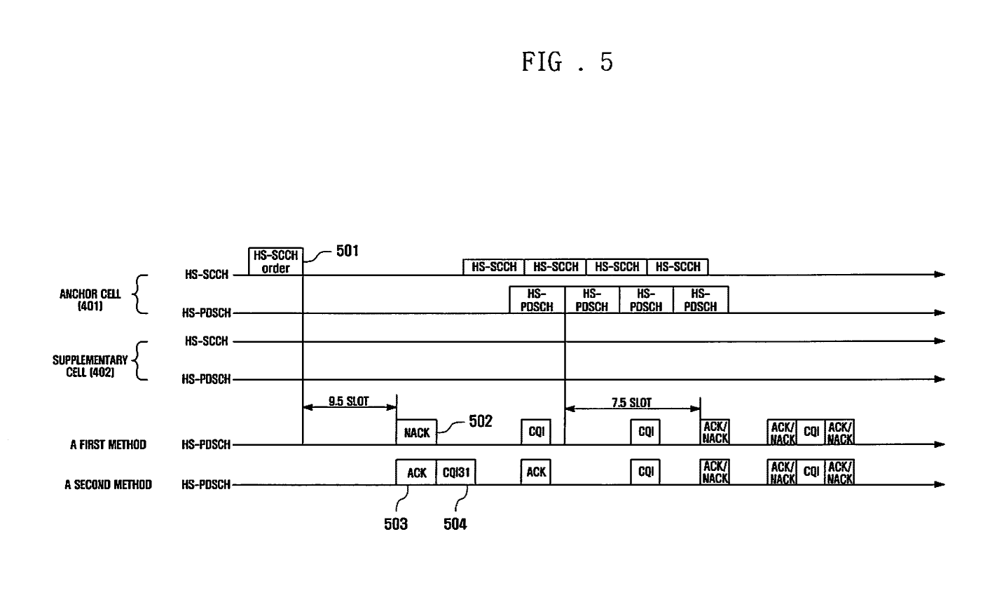

Conversely, FIG. 5 is a timing diagram illustrating transmissions of physical channels when the channel condition of the UE is bad according to an embodiment of the present invention.

Referring to FIG. 5, an HS-SCCH order for activating an HSDPA service of a supplementary cell is transmitted in the same manner as illustrated in FIG. 4, but a response to the HS-SCCH order is transmitted in different manner.

In accordance with an embodiment of the present invention, two different responding methods are provided.

The first responding method transmits a NACK 502, rather than an ACK, in response to the HS-SCCH.

The second responding method transmits an ACK 503 along with a CQI 504. In the second case, the CQI value of “31” can be used (CQI value 31 is not used currently). If a NACK or a CQI 31 message is received, a cell scheduler controls to transmit data via the anchor cell, rather than via both the anchor and supplementary cells. Also, in order to save uplink transmission power the UE transmits the CQI to the anchor cell, rather than to both the anchor and supplementary cells.

The UE can be configured to transmit the CQI for the anchor cell according to its own determination as aforementioned. It is also possible that the UE transmits the CQIs for the anchor and supplementary cells until it receives a deactivation command via the HS-SCCH order. The threshold value of the uplink power headroom can be set by a higher layer signaling or calculated using a predetermined power offset value of HS-DPCCH as will be described below.

The power offset vales to the transmit power of the ACK, NACK, and CQI as signaling transmitted through the HS-DPCCH are set by higher layer signaling. These values are called delt_ack(k), delta_nack(k), and delta_cqi(k). Here, k=1 indicates signaling transmitted via the HS-DPCCH for the anchor cell, and k=2 indicates signaling transmitted via the HS-DPCCH for the supplementary cell. The threshold value can be calculated as shown below in Equation (1).

Threshold[dB]=10*log 10(max(delta_{—}ack(1), delta_{—}nack(1), delta_{—}cqi(1))̂2)+max(delta_{—}ack(2), delta_{—}nack(2), delta_{—}cqi(2))̂2)) (1)

In Equation (1), the threshold value is determined by the maximum transmission power offsets of the two HS-DPCCHs, whereby, when the current Uplink Power Headroom (UPH) is equal to or greater than the threshold value, it is determined that the two HS-DPCCH can be transmitted normally.

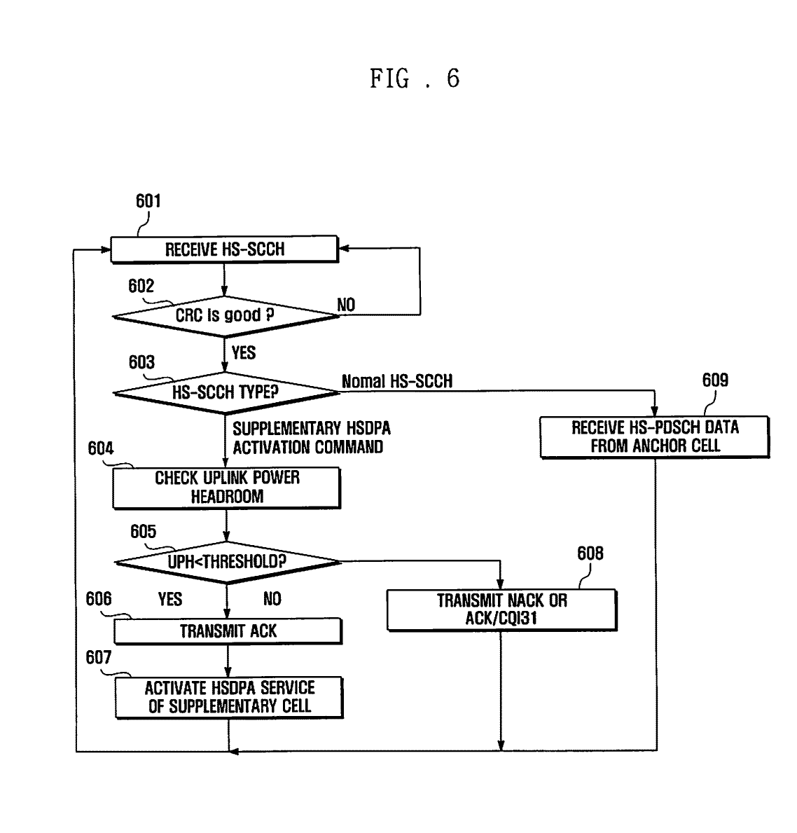

FIG. 6 is a flowchart illustrating a dynamic supplementary cell activation and deactivation method for a Dual-Cell HSDPA system in view of UE according to an embodiment of the present invention.

Referring to FIG. 6, a UE receives an HS-SCCH at a predetermined interval periodically in step 601. Because the Dual-Cell HSDPA service is not activated yet, the UE receives the HS-SCCH transmitted by the Node B only in the anchor carrier (anchor cell).

After the HS-SCCH is received, the UE determines whether the HS-SCCH has passed the CRC test in step 602. If the HS-SCCH has not passed the CRC test, this means that the UE was not scheduled at the time when the HS-SCCH was transmitted or an HS-SCCH order was not transmitted, and the process returns to step 601 for the UE to receive a next HS-SCCH. However, if the HS-SCCH has passed the CRC test in step 602, then the UE determines whether the HS-SCCH is an HS-SCCH order for activating the HSDPA service of the supplementary cell or a normal HS-SCCH carrying scheduling information in step 603. If the HS-SCCH is a normal HS-SCCH carrying scheduling information, the UE receives the HS-PDSCH of the anchor cell with reference to the scheduling information in step 609. Otherwise, if the HS-SCCH is an HS-SCCH order for activating the HSDPA service of the supplementary cell, the UE checks its current UPH in step 604 and compares the current UPH with a predetermined threshold value in step 605.

In step 605, if the current UPH is less than the threshold value, then the UE determines that it is difficult to support the Dual-Cell HSDPA service, and thus transmits a NACK or ACK/CQI 31 to the anchor cell in step 608. Otherwise, if the current UPH is equal to or greater than the threshold value, the UE determines that it is possible to support the Dual-Cell HSDPA service, and thus transmits an ACK to the anchor cell in response to the HS-SCCH order in step 606 and activates the HSDPA interface for the supplementary cell to start the Dual-Cell HSDPA mode in step 607.

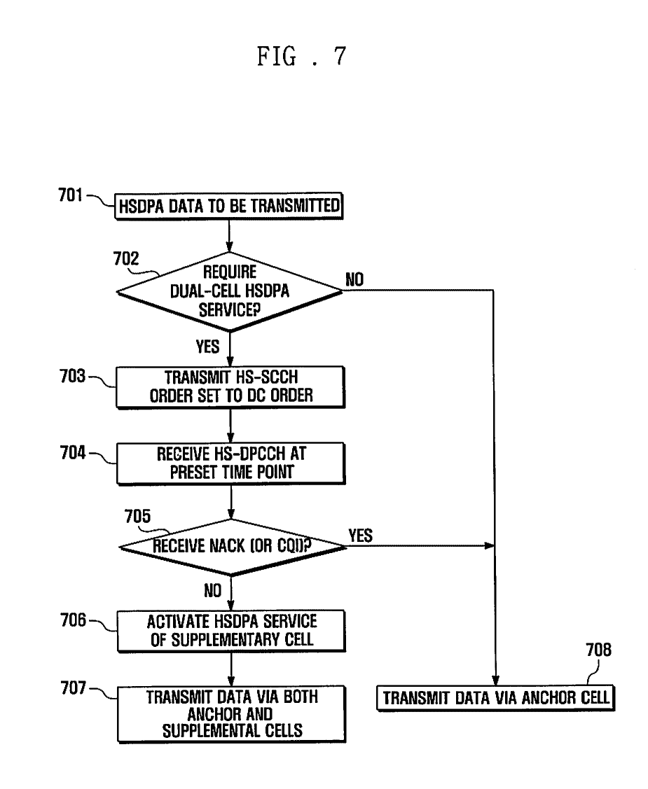

FIG. 7 is a flowchart illustrating a dynamic supplementary cell activation and deactivation method for a Dual-Cell HSDPA system in view of a Node B according to an embodiment of the present invention.

Referring to FIG. 7, the Node B first detects the HSDPA data destined for the UE in step 701.

Thereafter, the Node B determines whether the Dual-Cell HSDPA service is required for transmitting the HSDPA data to the UE in step 702. Whether the Dual-Cell HSDPA service is required or not can be determined based on the information such as a type and amount of downlink traffic (the HSDPA data). If it is determined that no Dual-Cell HSDPA service is required, the Node B transmits the HSDPA data to the UE through only the anchor carrier (the anchor cell) in step 708. Otherwise, if it is determined that the Dual-Cell HSDPA service is required, the Node B transmits the HS-SCCH order carrying the supplementary cell activation command to the UE in step 703.

After transmitting the HS-SCCH order carrying the supplementary cell activation command to the UE, the Node B receives the HS-DPCCH transmitted by the UE at a preset time point in step 704 and determines whether a NACK (or CQI) is received via the HS-DPCCH in step 705. If the NACK (or CQI) is received, this means that the UE cannot accommodate the Dual-Cell HSDPA service, and the Node B transmits the HSDPA data through the anchor carrier of the anchor cell in step 708. However, if no NACK (or CQI) is received, this means that the UE can accommodate the Dual-Cell HSDPA service, and the Node B activates the Dual-Cell HSDPA service in step 706 and transmits the HSDPA data through the anchor and supplementary carriers of the anchor and supplementary cells in step 707.

As another approach, if an ACK is received in step 705, the Node B activates the HSDPA service of the supplementary cell in order to transmit the HSDPA data through both the anchor and supplementary carriers. Further, if a NACK (or an ACK with CQI 31) is received (i.e., the UE cannot accommodate the Dual-Cell HSDPA service), the Node B transmits the HSDPA data through only the anchor carrier or processes the HSDPA data irrespective of the information transmitted by the UE according to the previous determination.

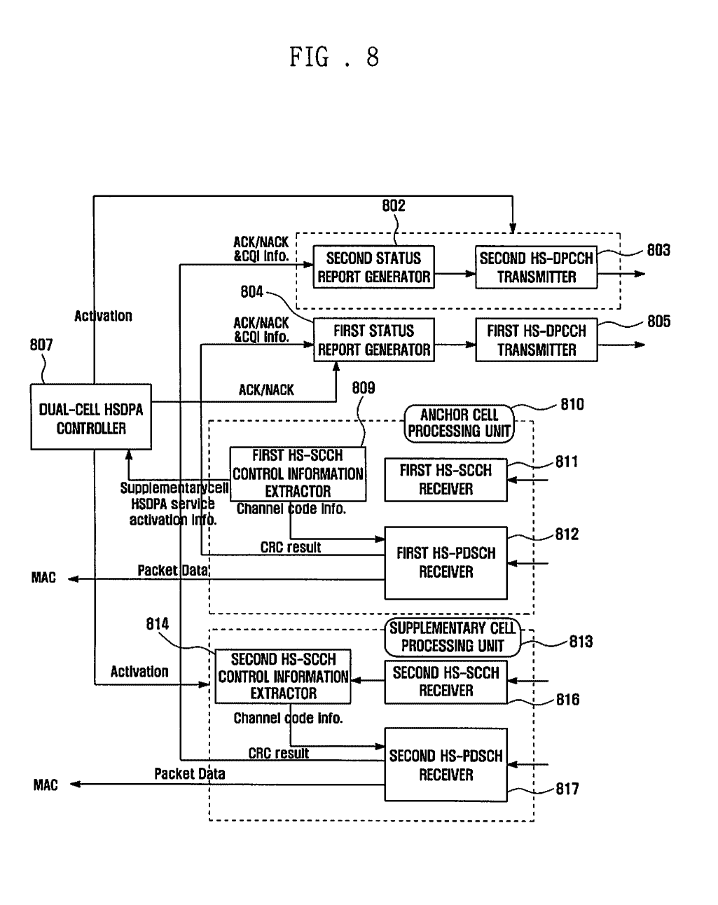

FIG. 8 is a block diagram illustrating a configuration of a UE for implementing the dynamic supplementary cell activation and deactivation method according to an embodiment of the present invention.

Referring to FIG. 8, the UE includes an anchor cell processing unit 810, a supplementary cell processing unit 813, a Dual-Cell HSDPA controller 807, a first status report generator 804, a first HS-DPCCH transmitter 805, a second status report generator 802, and a second HS-DPCCH transmitter 803. The anchor cell processing unit 810 includes a first HS-SCCH receiver 811, a first HS-PDSCH receiver 812, and a first HS-SCCH control information extractor 809. The supplementary cell processing unit 813 includes a second HS-SCCH receiver 816, a second HS-PDSCH receiver 817, and a second HS-SCCH control information extractor 814.

In order for the UE to receive the HSDPA service through two carriers (i.e., two cells), the UE is provided with two HS-SCCH channel receivers 811 and 816 and two HS-PDSCH channel receivers 812 and 817. The supplementary cell is activated in response to an HS-SCCH order transmitted by the Node B through the anchor carrier for the Dual-Cell HSDPA service. However, because the channel structure of the HS-SCCH carrying the HS-SCCH order is identical with the normal HS-SCCH for receiving the data scheduling information transmitted by the anchor cell, the UE can be configured with only a single HS-SCCH receiver 811 along with a single HS-SCCH control information extractor 809 (hereinafter, the term “HS-SCCH control information extractor” is used interchangeably with “supplementary cell activation command extractor”) for receiving both the HS-SCCH order and other HS-SCCH control information.

The first HS-SCCH control information extractor 809 of the anchor cell processing unit 801 extracts the supplementary cell activation command from the HS-SCCH received by the firs HS-SCCH receiver 811 and delivers the supplementary cell activation command to the Dual-Cell HSDPA controller 807 (hereinafter, the term “Dual-Cell HSDPA controller” is used interchangeably with “UE controller”).

After the supplementary cell activation command is received, the Dual-Cell HSDPA controller 807 compares the power condition indicated by the supplementary cell activation command transmitted by the UE with a threshold value. When the UE's power condition is greater than the threshold value, the Dual-Cell HSDPA controller 807 activates the supplementary cell processing unit 813 (i.e., the second HS-SCCH receiver 816 and the second HS-PDSCH receiver 817) to receive the Dual-Cell HSDPA service. The Dual-Cell HSDPA 807 also activates the second status report generator 802 and the second HS-DPCCH transmitter 803.

Thereafter, the Dual-Cell HSDPA controller 807 determines a control value in response to the HS-SCCH order and delivers the status report to the control value to the first status report generator 804. In accordance with an embodiment of the present invention, the first status report generator 804 can be a HS-DPCCH information generator or a response generator for generating a response message in response to the supplementary cell activation command transmitted by the Node B.

The Dual-Cell HSDPA controller 807 delivers the control value generated in response to the supplementary cell activation command to the first HS-DPCCH information generator 804, and the first HS-DPCCH information generator 804 (hereinafter, the term “status report generator” is used interchangeably with “response generator”) generates status report including ACK/NACK and/or CQI (HS-DPCCH) based on the control value and outputs the status report to the first HS-DPCCH transmitter 805, such that the first HS-DPCCH transmitter 805 transmits the status report to the Node B by means of HS-DPCCH. The HS-DPCCH carries the ACK message when the UE can accommodate the Dual-Cell HSDPA service or the NACK (or CQI 31) message when the UE cannot accommodate the Dual-Cell HSDPA service.

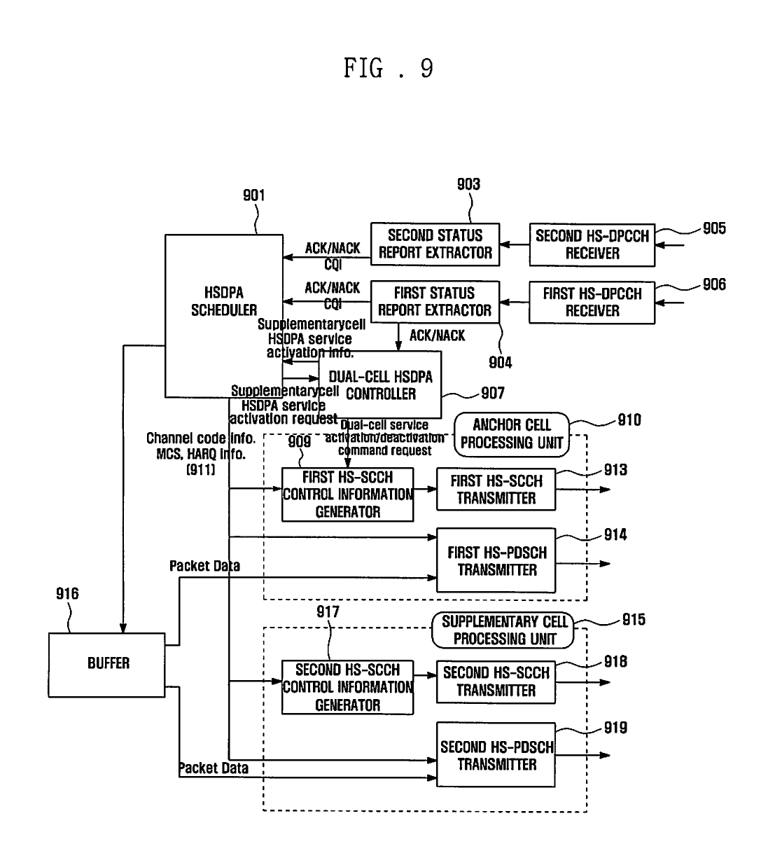

FIG. 9 is a block diagram illustrating a configuration of a Node B for implementing a dynamic supplementary cell activation and deactivation method according to an embodiment of the present invention.

Referring to FIG. 9, a Node B includes an anchor cell processing unit 910, a supplementary cell processing unit 915, a buffer 916, an HSDPA scheduler 901, a Dual-Cell HSDPA controller 907, a first HS-DPCCH receiver 906, a first status report extractor 904, a second HS-DPCCH receiver 905, and a second status report extractor 903. The anchor cell processing unit 910 includes a first HS-SCCH control information generator 912, a first HS-SCCH transmitter 913, and a first HS-PDSCH transmitter 914. The supplementary processing unit 915 includes a second HS-SCCH control information generator 917, a second HS-SCCH transmitter 918, and a second HS-PDSCH transmitter 919.

The Node B illustrated in FIG. 9 is depicted under the assumption that a single buffer and a single HSDPA scheduler are used in common to efficiently manage two cells for the Dual-Cell HSDPA service.

More specifically, the HSDPA determines a Transport Block Size (TBS) and informs the TBS of the anchor cell processing unit 910 and the supplementary cell processing unit 915. The anchor cell processing unit 910 and/or the supplementary cell processing unit 915 generate transport blocks with the packet data output by the buffer 916 with reference to the TBS and transmit the transport blocks using the HS-PDSCH transmitters 914 and 919. The HSDPA scheduler 901 also provides the anchor cell and supplementary cell processing units 910 and 915 with the channel codes, MCS, and HARQ information required for transmitting the HSDPA data. Such information is transmitted by both the first HS-SCCH transmitter 913 of the anchor cell processing unit 910 and the second HS-SCCH transmitter 918 of the supplementary cell processing unit 915 in order for the UE to demodulate and decode the HSDPA data carried by the HS-PDSCHs of the anchor and supplementary cells.

The Dual-Cell HSDPA controller 907 (hereinafter, the term “Dual-Cell HSDPA controller is used interchangeably with “Node B controller”) outputs a control signal indicating whether to activate/deactivate the Dual-Cell HSDPA service to the HSDPA scheduler 901. If the control signal indicates activation of the Dual-Cell HSDPA service, the HSDPA scheduler 901 schedules the HSDPA data to be transmitted through both the anchor and supplementary carriers (i.e., the anchor and supplementary cells). Otherwise, if the control signal indicates deactivation of the Dual-Cell HSDPA service, the HSDPA scheduler 901 schedules the HSDPA data to be transmitted through only the anchor carrier (i.e., the anchor cell).

Even when the Dual-Cell HSDPA service is deactivated, the HSDPA scheduler 901 can request the Dual-Cell HSDPA controller 907 to activate the Dual-Cell HSDPA service, if required according to its own judgment. In this case, the Dual-Cell HSDPA controller 907 outputs the transmission request information to the first HS-SCCH control information generator 912 of the anchor cell processing unit 910 (or the second HS-SCCH control information generator 917 of the supplementary cell processing unit 915), such that the HS-SCCH order is transmitted by the first HS-SCCH transmitter 913 or the second HS-SCCH transmitter 918. The HS-DPCCH carrying the response message transmitted by the UE in response to the HS-SCCH order is received through the first HS-DPCCH receiver 906. The first status report extractor 904 (hereinafter, the term “status report extractor” is used interchangeably with “response extractor”) extracts the ACK/NACK information from the HS-DPCCH received by the first HS-DPCCH receiver 906 and delivers the ACK/NACK information to the Dual-Cell HSDPA controller 907. Because the response message is carried by the HS-DPCCH transmitted at a time when a fixed time duration elapsed from the transmission of the HS-DPCCH order, such that the Node B can identify the ACK/NACK (CQI) message transmitted in response to the HS-SCCH order.

In accordance with an embodiment of the present invention, a Node B activates a Dual-Cell HSDPA service and transmits an HS-SCCH order. Upon receipt of the HS-SCCH order, a UE checks its UPH and, if the UPH is less than a threshold value, transmits the UPH information via an Enhanced Dedicated Physical Data Control Channel (E-DPDCH).

This embodiment is similar with the embodiments described above, except that the raw UPH information is transmitted via the E-DPDCH, rather than transmitting the NACK (or ACK with CQI 31) when the UPH is less than the threshold value. The status report via the E-DPDCH is advantageous as more detailed power conditions of the UE can be reported to the Node B using the preexisting signaling mechanism without an additional signaling channel as used in the above-described embodiments.

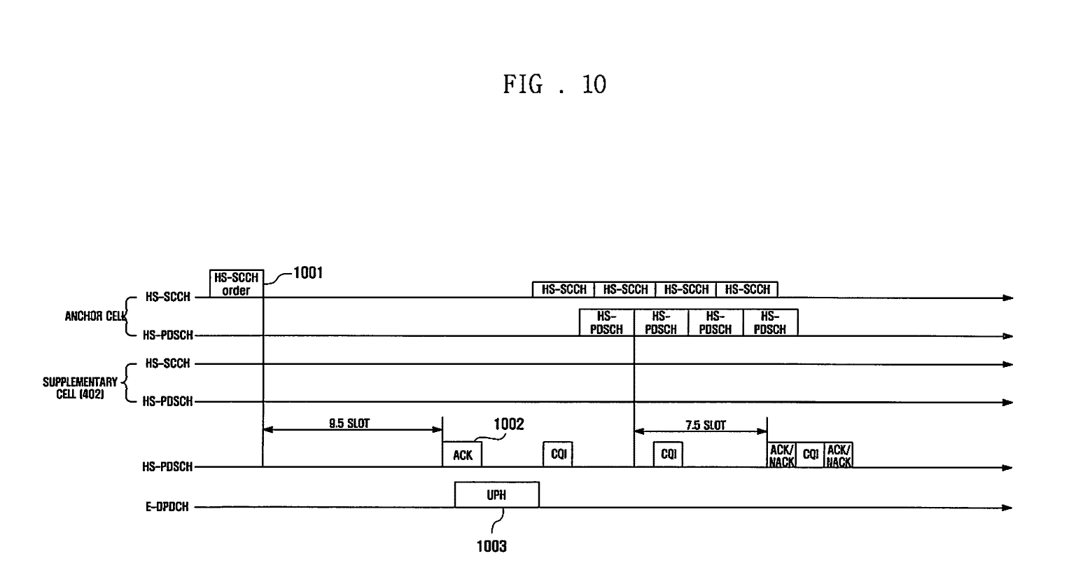

FIG. 10 is a timing diagram illustrating transmissions of channels according to an embodiment of the present invention.

The operations of the Node B and UE are identical with those illustrated in FIG. 4, when the power condition of the UE is good and can accommodate the Dual-Cell HSDPA service. Accordingly, a repetitive detailed description is omitted herein.

However, FIG. 10 illustrates the operations of the Node B and UE when the UE cannot accommodate the Dual-Cell HSDPA service due to a lack of transmission power. When an HS-SCCH order 1001 for activating the dual HSDPA service is received, the UE transmits an ACK 1002 indicating safe receipt of the HS-SCCH order via the HS-DPCCH and the UPH information 1003 via the E-DPDCH.

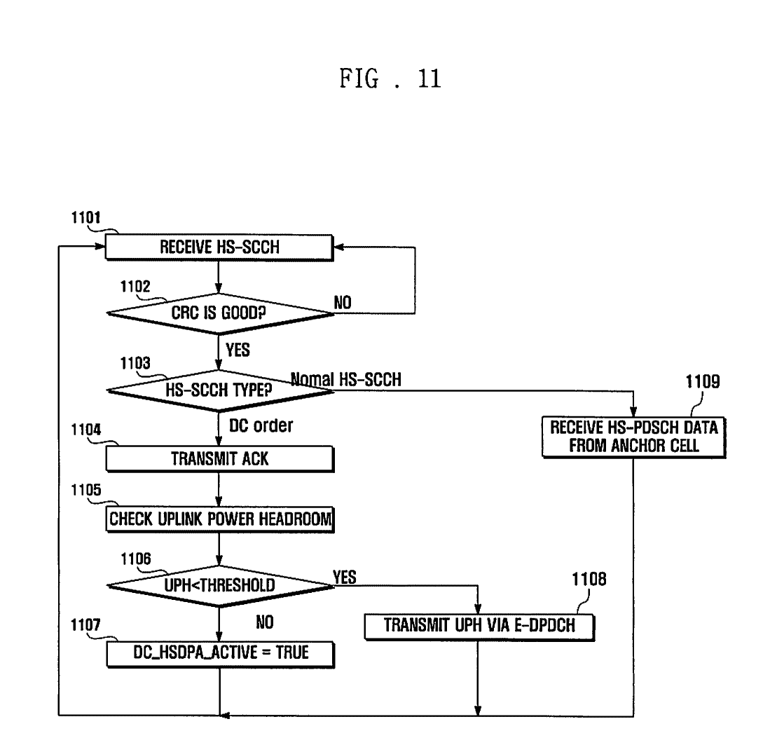

FIG. 11 is a flowchart illustrating a dynamic supplementary cell activation and deactivation method for a Dual-Cell HSDPA system in view of UE according to an embodiment of the present invention.

Referring to FIG. 11, the UE periodically receives an HS-SCCH at a predetermined interval in step 1101. Because the Dual-Cell HSDPA service is not activated yet, the UE receives the HS-SCCH transmitted by the Node B only in the anchor carrier (anchor cell).

After the HS-SCCH is received, the UE determines whether the HS-SCCH has passed the CRC test, i.e., if the CRC is good, in step 1102. If the HS-SCCH has not passed the CRC test, this means that the UE was not scheduled at the time when the HS-SCCH was transmitted or an HS-SCCH order was not transmitted, and the process returns to step 1101 for the UE to receive a next HS-SCCH. However, if the HS-SCCH has passed the CRC test at step 1102, then the UE determines whether the HS-SCCH is an HS-SCCH order for activating HSDPA service of the supplementary cell or a normal HS-SCCH carrying the scheduling information in step 1103.

If the HS-SCCH is a normal HS-SCCH carrying the scheduling information, the UE receives the HS-PDSCH of the anchor cell with reference to the scheduling information in step 1109. Otherwise, if the HS-SCCH is the HS-SCCH order for activating the HSDPA service of the supplementary cell, then the UE transmits the ACK in response to the HS-SCCH order in step 1104.

Thereafter, the UE checks its UPH in step 1105 and determines whether the UPH is less than a predetermined threshold value in step 1106. If the UPH is less than the threshold value, then the UE transmits the UPH through the E-DPDCH in step 1108. Otherwise, if the UPH is equal to or greater than the threshold value, then the UE transmits a Dual-Cell HSDPA activation response (DC_HSDPA_Active=True) to the Node B in step 1107.

The threshold value of the UPH can be set by higher layer signaling, or calculated using the power offset value of the HS-DPCCH.

As described above, the power offset values to the transmit power of the ACK, NACK, and CQI as signaling transmitted through the HS-DPCCH can be set by higher layer signaling. The values are called delt_ack(k), delta_nack(k), and delta_cqi(k). Here, k=1 indicates signaling transmitted via the HS-DPCCH for the anchor cell, and k=2 indicates signaling transmitted via the HS-DPCCH for the supplementary cell. The threshold value can be calculated as shown and described above in Equation (1).

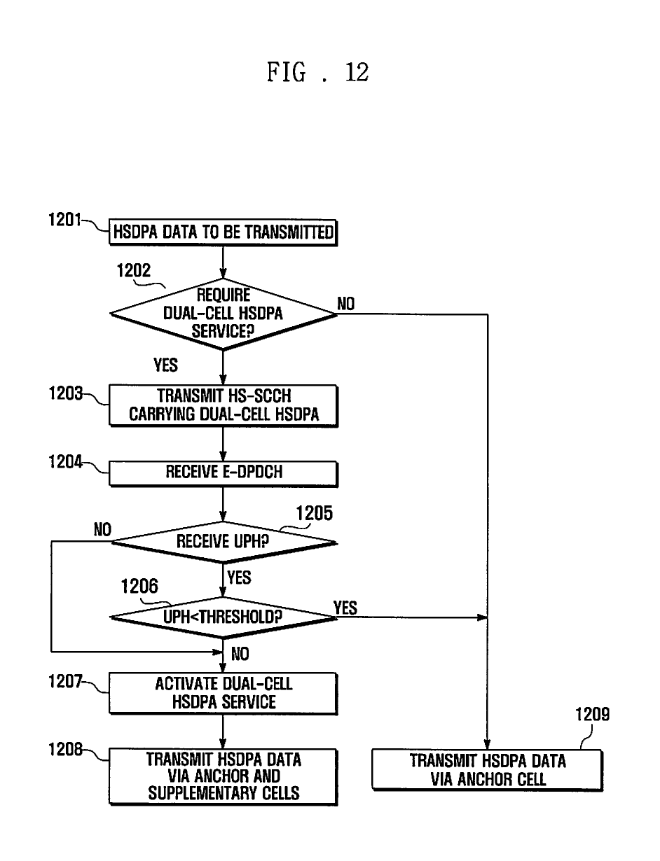

FIG. 12 is a flowchart illustrating a dynamic supplementary cell activation and deactivation method for a Dual-Cell HSDPA system in view of a Node B according to an embodiment of the present invention.

Referring to FIG. 12, a Node B first detects the HSDPA data destined for the UE in step 1201. Thereafter, the Node B determines whether the Dual-Cell HSDPA service is required for transmitting the HSDPA data to the UE in step 1202. Whether the Dual-Cell HSDPA service is required or not can be determined based on the information such as downlink traffic amount and type (the HSDPA data). If it is determined that no Dual-Cell HSDPA service is required, the Node B transmits the HSDPA data to the UE through only the anchor carrier (the anchor cell) in step 1209. Otherwise, if it is determined that the Dual-Cell HSDPA service is required, the Node B transmits the HS-SCCH order carrying the supplementary cell activation command to the UE in step 1203.

After the Node B transmits the HS-SCCH order carrying the supplementary cell activation command to the UE, the Node B receives the E-DPDCH at a predetermined time in step 1204 and determines whether a UPH is carried by the E-DPDCH in step 1205. If no UPH is carried by the E-DPDCH, this means that the UE accepts the Dual-Cell HSDPA service, and the Node B activates the Dual-Cell HSDPA service in step 1207 and transmits the HSDPA data to the UE via the anchor and supplementary carriers (anchor and supplementary cells) in step 1208. Otherwise, if the UPH is carried by the E-DPDCH at step 1205, the Node B determines whether the UPH is less than a predetermined threshold value in step 1206.

Step 1206 is performed because the UPH information can be used for other purposes, other than for determining the activation of the Dual-Cell HSDPA service. If the UPH is equal to or greater than the threshold value, this means that the UE can accommodate the Dual-Cell HSDPA service, and the Node B activates the Dual-Cell HSDPA service in step 1207 and transmits the HSDPA data to the UE via the anchor and supplementary carriers in step 1208. Otherwise, if the UPH is less than the threshold value at step 1206, the Node B transmits the HSDPA data to the UE via only the anchor carrier in step 1209.

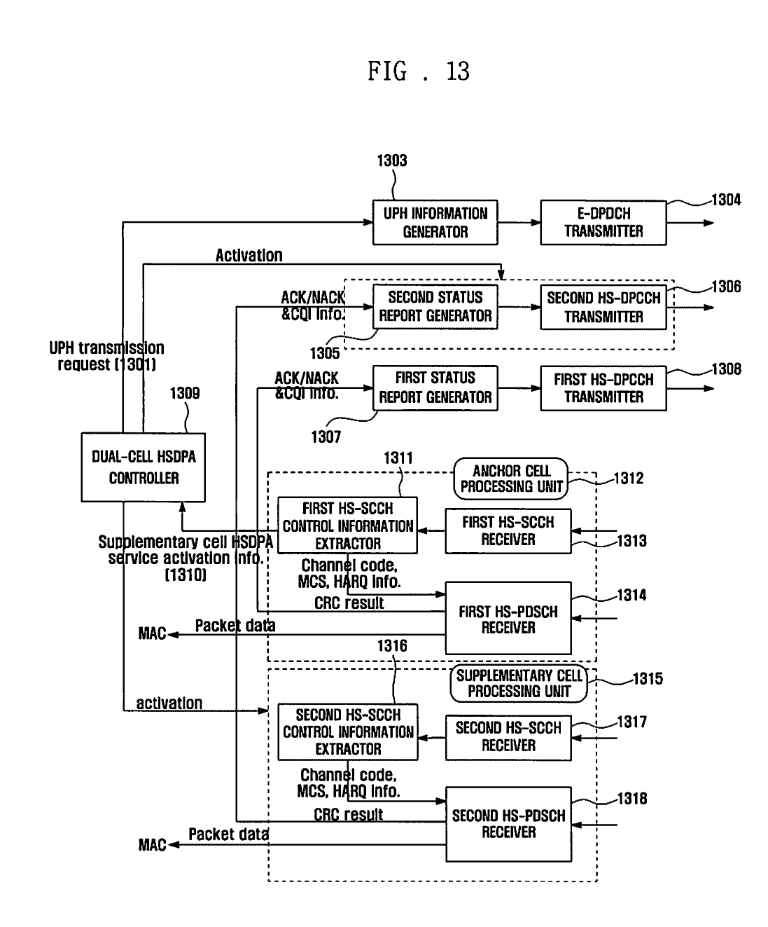

FIG. 13 is a block diagram illustrating a configuration of a UE for implementing a dynamic supplementary cell activation and deactivation method according to an embodiment of the present invention.

Referring to FIG. 13, the UE includes an anchor cell processing unit 1312, a supplementary cell processing unit 1315, a Dual-Cell HSDPA controller 1309, a first status report generator 1307, a first HS-DPCCH transmitter 1308, a second status report generator 1305, a second HS-DPCCH transmitter 1306, a UPH information transmitter 1303, and an E-DPDCH transmitter 1304. The anchor cell processing unit 1312 includes a first HS-SCCH receiver 1313, a first HS-PDSCH receiver 1314, and a first HS-SCCH control information extractor 1311. The supplementary cell processing unit 1315 includes a second HS-SCCH receiver 1317, a second HS-PDSCH receiver 1318, and a second HS-SCCH control information extractor 1316. Although the UPH information generator 1303 is separately depicted in FIG. 13, the UPH information generator 1303 also can be included in any or both of the first and second status report generators 1307 and 1305, or the UPH information generator 1303 can include at least one of the first and second status report generators 1307 and 1305.

The UE illustrated in FIG. 13 is similar to the UE illustrated in FIG. 8 in structure and operation, except that a UPH information generator 1303 and an E-DPDCH transmitter 1304 are further included for transmitting the UPH information when the UPH is less than the threshold value. Although the UPH information generator 1303 is depicted as an additional function block in FIG. 13, the UPH information generator 1303 can replace at least one of the first and second status report generators 1305 and 1307. In this case, the UPH information generator 1303 can be a response generator for generating a response message in response to the supplementary cell activation command transmitted by the Node B. The UPH information generated by the UPH information generator 1303 is transmitted by the E-DPDCH transmitter 1304.

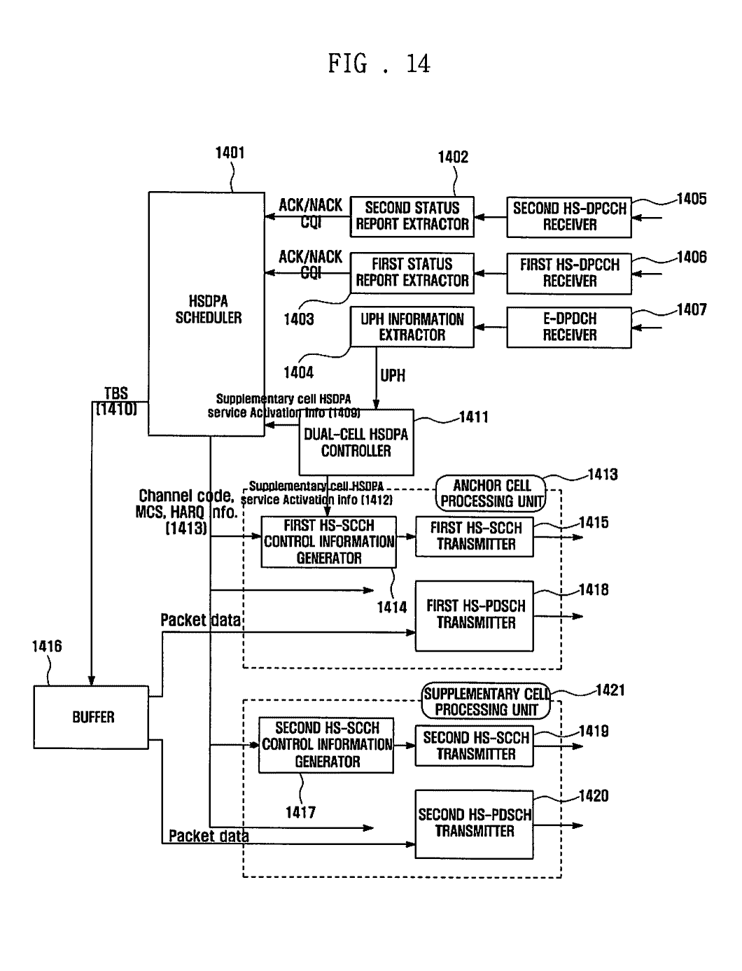

FIG. 14 is a block diagram illustrating a configuration of a Node B for implementing a dynamic supplementary cell activation and deactivation method according to an embodiment of the present invention.

Referring to FIG. 14, the Node B includes an anchor cell processing unit 1413, a supplementary cell processing unit 1421, a buffer 1416, an HSDPA scheduler 1401, a Dual-Cell HSDPA controller 1411, a first HS-DPCCH receiver 1406, a first status report extractor 1403, a second HS-DPCCH receiver 1405, a second status report extractor 1402, an E-DPDCH receiver 1407, and a UPH information extractor 1404. The anchor cell processing unit 1413 includes a first HS-SCCH control information generator 1414, a first HS-SCCH transmitter 1415, and a first HS-PDSCH transmitter 1418. The supplementary processing unit 1421 includes a second HS-SCCH control information generator 1417, a second HS-SCCH transmitter 1419, and a second HS-PDSCH transmitter 1420. Although the UPH information extractor 1404 is separately depicted in FIG. 14, the UPH information extractor 1404 also can be included in any or both of the first and second status report extractors 1403 and 1402, or the UPH information extractor 1404 can include at least one of the first and second status report extractors 1403 and 1402.

The Node B illustrated in FIG. 14 is similar to the Node B illustrated in FIG. 9 in structure and operation, except that a UPH information extractor 1404 and an E-DPDCH receiver 1407 are further included for receiving the UPH information transmitted by the UE in response to the supplementary cell activation command.

In accordance with an embodiment of the present invention, if the network is set to support a Dual-Cell HSDPA service, a UE transmits UPH information. Unlink a conventional method in which the UPH information is not transmitted when the uplink buffer of the UE is empty, the UE operating in the Dual-Cell HSDPA mode according to this embodiment of the present invention transmits the UPH information irrespective of the presence of uplink data.

Further, unlike the supplementary cell activation method described above, in which the UE transmits the UPH when it can accommodate the Dual-Cell HSDPA service, the supplementary cell activation method in accordance with this embodiment of the present invention enables a UE to transmit UPH information irrespective of a receipt of an HS-SCCH order when the Dual-Cell HSDPA service is activated, i.e., when the UE receives a supplementary cell activation command.

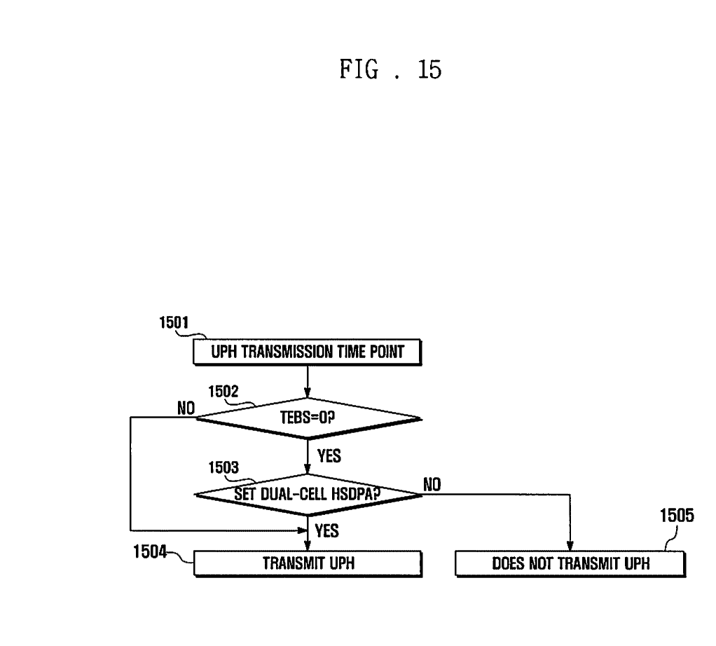

FIG. 15 is a flowchart illustrating a dynamic supplementary cell activation method for a Dual-Cell HSDPA system in view of a UE according to an embodiment of the present invention. In FIG. 15, it is assumed that UPH information is transmitted periodically.

Referring to FIG. 15, a UE first detects that a UPH transmission time is reached in step 1501. Thereafter, the UE determines whether the uplink buffer (Total E-DCH buffer status: TEBS) is empty in step 1502. Whether the buffer is empty or not can be determined by checking the TEBS. If the TEBS is set to 0, this means that the uplink buffer is empty. The UPH information is used for uplink scheduling such that there is no need to transmit the UPH information when the uplink buffer is empty. If the uplink buffer is not empty (i.e., TEBS≠0), the UE transmits the UPH information to the Node B in step 1504. If the uplink buffer is empty (i.e., TEBS=0) in step 1502, the UE determines whether the Dual-Cell HSDPA service of the network is activated in step 1503. Step 1503 is performed, because it is beneficial to transmit the UPH even when the TEBS=0 in order to efficiently manage the Dual-Cell HSDPA service. If the Dual-Cell HSDPA service of the network is activated, the UE transmits the UPH information to the Node B in step 1504. Otherwise, if the Dual-Cell HSDPA service of the network is deactivated, the UE does not transmit the UPH information in step 1505.

As described above, supplementary cell activation and deactivation methods for a mobile communication system supporting dual-cell HSDPA service enable a UE to inform a Node B of an unavailability of a Dual-Cell HSDPA, when it receives an HS-SCCH order transmitted by the Node B with an activation of the Dual-Cell HSDPA service and cannot accommodate the Dual-Cell HSDPA service in consideration of its uplink power headroom. Consequently, the efficiency of the Dual-Cell HSDPA service is improved and power consumption of the UE is reduced.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A supplementary cell activation and deactivation method of a user equipment for a Wideband Code Division Multiple Access (WCDMA) system supporting multi-carrier transmission, the method comprising:
receiving a supplementary cell activation command from a base station;
comparing an uplink transmission power with a predetermined threshold value;
transmitting a supplementary cell activation reply in response to the supplementary cell activation command, when the uplink transmission power is equal to or greater than the threshold value; and
transmitting a supplementary cell deactivation reply in response to the supplementary cell activation command, when the uplink transmission power is less than the threshold value.

2. The supplementary cell activation and deactivation method of claim 1, wherein transmitting the supplementary cell deactivation reply comprises sending a negative acknowledgement (NACK).

3. The supplementary cell activation and deactivation method of claim 1, wherein transmitting the supplementary cell deactivation reply comprises sending an acknowledgement (ACK) and a channel quality indicator.

4. The supplementary cell activation and deactivation method of claim 1, wherein transmitting the supplementary cell deactivation reply comprises:
sending an acknowledgement (ACK) in response to the supplementary cell activation command; and
sending an Uplink Power Headroom (UPH) of the user equipment.

5. The supplementary cell activation/deactivation method of claim 1, further comprising transmitting an Uplink Power Headroom (UPH) of the user equipment to the base station.

6. A supplementary cell activation and deactivation method of a base station for a Wideband Code Division Multiple Access (WCDMA) system supporting multi-carrier transmission, the method comprising
receiving a reply from a user equipment in response to a supplementary cell activation command; and
activating a supplementary cell, when the reply is a supplementary cell activation reply, and deactivating the supplementary cell, when the reply is a supplementary cell deactivation reply.

7. The supplementary cell activation and deactivation method of claim 6, wherein the supplementary cell deactivation reply includes a negative acknowledgement (NACK).

8. The supplementary cell activation and deactivation method of claim 6, wherein the supplementary cell deactivation reply includes an acknowledgement (ACK) and a channel quality identifier.

9. The supplementary cell activation and deactivation method of claim 6, wherein the reply includes an acknowledgement (ACK) in response to the supplementary cell activation command, and an Uplink Power Headroom (UPH) of the user equipment.

10. The supplementary cell activation and deactivation method of claim 6, further comprising receiving an Uplink Power Headroom (UPH) of the user equipment.

11. A user equipment for activating and deactivating supplementary cell in a Wideband Code Division Multiple Access (WCDMA) system supporting multi-carrier transmission, comprising:
a supplementary cell activation command extractor for extracting a supplementary cell activation command from a channel transmitted by a base station;
a status report generator for generating a response to the supplementary cell activation command; and
a controller for comparing an uplink power with a predetermined threshold value and controlling the status report generator to generate and transmit a supplementary cell activation response, when the uplink power is equal to or greater than the threshold value, and to generate and transmit a supplementary cell deactivation response, when the uplink power is less than the threshold value.

12. The user equipment of claim 11, wherein the supplementary cell deactivation response comprises a negative acknowledgement (NACK).

13. The user equipment of claim 11, wherein the supplementary cell deactivation response comprises:
an acknowledgement (ACK); and
a channel quality indicator.

14. The user equipment of claim 11, wherein the supplementary cell deactivation response comprises:
an acknowledgement (ACK); and
an Uplink Power Headroom (UPH) of the user equipment.

15. The user equipment of claim 11, wherein the controller checks an Uplink Power Headroom (UPH) of the user equipment and transmits the UPH in response to the supplementary cell activation command.

16. A base station for activating and deactivating supplementary cell in a Wideband Code Division Multiple Access (WCDMA) system supporting multi-carrier transmission, comprising:
a supplementary cell activation command generator for generating and transmitting a supplementary cell activation command to a user equipment;
a status report extractor for extracting a response from a channel transmitted by the user equipment, in response to the supplementary cell activation command; and
a controller for activating a supplementary cell, when the response is a supplementary cell activation response, and for deactivating the supplementary cell, when the response is a supplementary cell deactivation response.

17. The base station of claim 16, wherein the supplementary cell deactivation response comprises a negative acknowledgement (NACK).

18. The base station of claim 16, wherein the supplementary cell deactivation response comprises:
an acknowledgement (ACK); and
a channel quality indicator.

19. The base station of claim 16, wherein the supplementary cell deactivation response comprises:
an acknowledgement (ACK); and
an Uplink Power Headroom (UPH) of the user equipment.

20. The base station of claim 16, wherein the supplementary cell deactivation response comprises an Uplink Power Headroom (UPH) of the user equipment.
